(19) United States
(12) Patent Application Publication
(10) Pub. No.: US 2011/0113901 A1
(43) Pub. Date: May 19, 2011

(54) APPARATUS AND METHOD FOR PROCESSING A FLUIDIC SAMPLE

(76) Inventor: Bernard A. Gonzalez, St Paul, MN (US)

(21) Appl. No.: 12/674,842

(22) PCT Filed: Aug. 20, 2008
(86) PCT No.: PCT/US08/73647

§ 371 Date: Feb. 23, 2010

Related U.S. Application Data
(60) Provisional application No. 60/968,226, filed on Aug. 27, 2007.

(51) Int. Cl. G01N 1/28

(52) U.S. Cl. 73/864

(57) ABSTRACT

The application discloses an apparatus and method for processing a sample of material. In one embodiment, the apparatus includes a multi-layered structure including a plurality of deformable chambers and a flow passage or passages in fluid communication with at least one of the plurality of deformable chambers. In another embodiment, the apparatus includes a pressure device having a pressure pattern to compress or squeeze at least one deformable chamber of the apparatus.

### BACKGROUND

Many industries, such as clinical diagnostic and food processing industries, test samples of material in order to determine whether certain analytes, such as pathogenic bacteria or allergens, are present in the samples. Typically, the test samples are either in a liquid or solid form, and are obtained using a sample collection device that is appropriate for the type of sample. In some instances, the sample may be subjected to other procedures, such as concentration or dilution, to prepare the sample for detection of specific analytes. For processing and testing, the sample is typically transferred to a glass slide a test tube, or a 96-well plate, and mixed or combined with other fluids or reagents to facilitate the detection of the analyte. The processes of transferring a sample, mixing or combining a sample with solutions or reagents, and detecting analytes are all points of potential contamination. Contamination of the sample potentially could result in false or misleading results in the subsequent analyte testing. It would be advantageous, therefore, to provide a self-contained device to minimize exposure of the sample materials or reagents during the sample preparation and sample analysis.

### SUMMARY

The present invention relates an apparatus and method for processing a sample of material.

The above summary is not intended to describe each disclosed embodiment or every implementation of the present invention. The figures and the detailed description which follow more particularly exemplify illustrative embodiments.

### BRIEF DESCRIPTION OF THE DRAWINGS

The present invention will be further explained with reference to the drawing figures listed below, where like structure is referenced by like numerals throughout the several views.

FIG. 1 schematically illustrates a processing or testing apparatus including a deformable chamber which is compressed to expel fluid.

FIG. 2 is a schematic illustration of a multi-layer construction for fabricating the deformable chamber illustrated in FIG. 1.

FIG. 3 schematically illustrates a sealing agent to restrict fluid flow.

FIG. 4 schematically illustrates a processing sequence including a plurality of fraction chambers in fluid communication with a deformable chamber.

FIG. 5 schematically illustrates a processing sequence including a plurality of deformable chambers.

FIG. 6 schematically illustrates a processing sequence including a plurality of deformable chambers for mixing.

FIGS. 7A-7E progressively illustrate a mixing sequence embodiment.

FIGS. 8-10 illustrate an embodiment of a processing or testing apparatus having a radial sequenced pattern.

FIGS. 10A-10B illustrate a radial sequenced pressure pattern.

FIG. 11 is a flow chart illustrating processing steps for the radial sequenced pattern of FIGS. 8-10.

FIG. 12 illustrates an embodiment of a processing or testing apparatus having a linear sequenced pattern.

FIG. 13 illustrates the embodiment of the processing or testing apparatus having the linear sequenced pattern in combination with a linear sequenced pressure device.

FIG. 13A illustrates a plurality of pressure ridges or ribs for a linear sequenced pressure pattern.

FIG. 14 schematically illustrates an apparatus including a card portion having a plurality of deformable chambers compressed via a pressure device coupled to the card portion via a hinge.

FIG. 15 schematically illustrates a timing mass for controlling fluid flow from a deformable chamber.

FIGS. 16-17 schematically illustrate a card or apparatus.

FIG. 17A illustrates a plurality of parallel chambers and passages fabricated between a plurality of layers.

FIGS. 18-22 cooperatively illustrate processing steps for processing a sample of material.

While the above-identified figures set forth several exemplary embodiments of the present invention, other embodiments are also within the invention. In all cases, this disclosure presents the invention by way of representation and not limitation. It should be understood that numerous other modifications and embodiments can be devised by those skilled in the art, which fall within the scope and spirit of the principles of the invention.

### DETAILED DESCRIPTION

The present invention includes a processing apparatus having a deformable chamber to express fluid for processing or testing a sample. In illustrative embodiments, the deformable chamber is used in combination with additional chambers and passages to implement a processing pattern or sequence, for example for detecting an analyte, such as Staphylococcus aureus, in a sample of material.

The apparatus described herein can be combined to form a processing sequence for an indirect or direct assay to detect an analyte in a sample material or other testing process. The chambers and/or passages of the apparatus can include the detection process for the analyte, or the chambers and/or passages can be used to prepare the sample material for detection in a separate device. An exemplary analyte of interest to detect is Staphylococcus aureus (“S. aureus”). This is a pathogen causing a wide spectrum of infections including: superficial lesions such as small skin abscesses and wound infections; systemic and life threatening conditions such as endocarditis, pneumonia and septicemia; as well as toxinoses such as food poisoning and toxic shock syndrome.

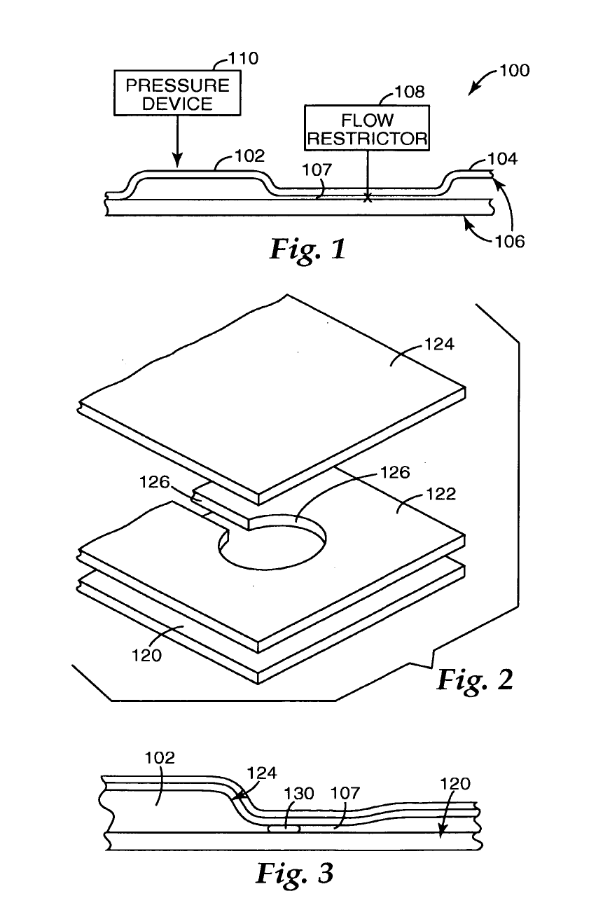

FIG. 1 schematically illustrates an apparatus 100 including a deformable chamber 102 in combination with chamber 104 fabricated between a plurality of layers 106. The chamber 104 is in fluid communication with the deformable chamber 102 via a passage or channel 107 between the plurality of layers 106. Fluid is retained in the deformable chamber 102 via a flow restrictor 108 (for example, a frangible restrictor or seal) between the deformable chamber 102 and chamber 104. Fluid is expressed from the deformable chamber 102 via a pressure device 110. Pressure device 110 is configured to supply pressure to compress or deform the chamber 102 to facilitate fluid flow from the chamber 102 through passage 107. Deformable chamber 102 and optionally passage 107 can be formed of an elastic or inelastic material depending upon the process application as will be described.

FIG. 2 illustrates a multi-layer structure for fabricating the deformable chamber 102 of apparatus 100 illustrated in FIG. 1. As shown, the multi-layer construction includes a first layer or layers 120, an adhesive layer 122 and second layer or layers 124. The adhesive layer 122 is patterned so that portions of the second layer or layers 124 selectively adhere to the first layer or layers 120 to form the deformable chamber 102 therebetween. As shown in FIG. 2, portions of the second layer or layers 124 proximate to void areas 126 do not adhere to the first layer or layers 120 to form a void space or pocket defining the deformable chamber 102, passage 107 or other features of the apparatus 100.

In illustrative embodiments, the second layer or layers 124 include portions or layers formed of different materials to provide different properties for different flow features or chambers on apparatus 100. For example, the deformable chamber 102 can be formed of a first deformable material, and chamber 104 can be formed of a second stiffer material, such as polyethylene terephthalate (PET), to form a relatively rigid chamber. Passage 107 can be formed of a third material, which can be deformable such as polypropylene, to allow passage 107 can be impinged to restrict flow therethrough. Passage 107 may be formed of deformable material or a stiffer material such as that used for chamber 104.

Deformable materials preferably are materials that demonstrate elastic or elastomeric recovery. The elastic materials used to impart elastic recovery properties to the deformable materials of the invention are well known and generally include substances such as synthetic rubber or plastic, which, at room temperature, can be stretched under stress to at least twice their original length, and, upon immediate release of stress, will return with force to their approximate original length.

Potentially suitable elastic materials include natural rubber, synthetic rubber or thermoplastic polymers. Suitable synthetic rubbers include ether-based polyurethane Spandex, ester-based polyurethane Spandex, SBR styrene butadiene rubber, EPDM ethylene propylene rubber, fluororubbers, silicone rubber and NBR nitrile rubber. Additional suitable thermoplastic elastomers include block copolymers having the general formula A-B-A′ where A and A′ are each a thermoplastic polymer endblock which contains a styrenic moiety such as a poly (vinyl arene) and where B is an elastomeric polymer midblock such as a conjugated diene or a lower alkene polymer. The block copolymers may be, for example, (polystyrene/poly(ethylene-butylene)/polystyrene) block copolymers available from the Shell Chemical Company under the name KRATON. Other suitable elastomeric materials include polyurethanes, acrylics, and acrylic-olefinic copolymers, other elastic polyolefins, as well as polyamide elastomeric materials and polyester elastomeric materials. In a preferred embodiment, the deformable materials include a polyolefin foam or a polypropylene material.

The patterned adhesive layer 122 is formed of a pressure sensitive or heat sensitive adhesive. In an alternate embodiment, portions of the second layer or layers 124 are adhered or heat sealed to the first layer or layers 120 in a desired arrangement to form the deformable chambers 102, passage 107, and other features without application of the patterned adhesive layer 122 illustrated in FIG. 2.

In the embodiment illustrated in FIG. 3, the multiple layer structure includes a sealing portion 130 between the second layer or layers 124 and first layer 120 to form the flow restrictor 108 illustrated in FIG. 1. Sealing portion 130 may be a relatively rigid mass or plug that remains in place until pressure is applied to deformable chamber 102. Alternatively, sealing portion 130 may be an adhesive attachment. Preferably, sealing portion 130, as well as other materials used for the apparatus 100, is biologically inert. In the illustrative embodiment, the sealing portion 130 is an adhesive attachment that binds the second layers 124 to the first layer 120 to restrict fluid flow. The adhesion force of the sealing portion 130 is designed to release the second layer 124 from the first layer or layers 120 upon application of sufficient pressure to express fluid from deformable chamber 102. In alternate embodiments, pressure can be supplied to the sealing portion 130 (e.g., via pressure device 110) to seal passage 107 to restrict fluid flow as will be described. In an illustrative embodiment wherein the sealing portion 130 is a mass or plug, the sealing portion 130 can be fabricated of a low density polyolefin or wax which can be easily ruptured under pressure, but which is maintains a seal during shipping and handling of the apparatus 100.

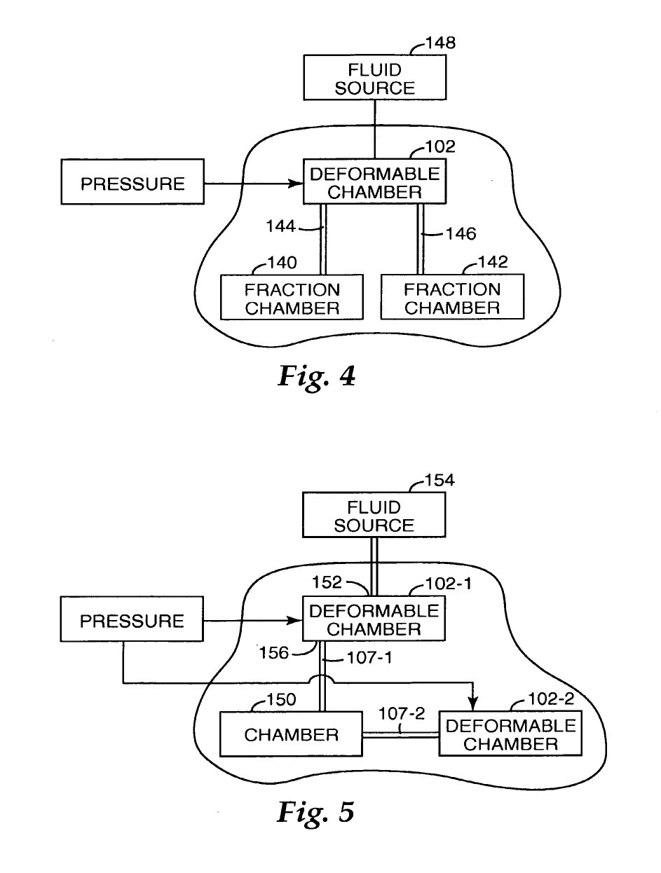

In the embodiment illustrated in FIG. 4, the deformable chamber 102 is used in combination with a plurality of smaller fraction chambers 140, 142. As shown, fraction chambers 140, 142 are fluidly connected in parallel to chamber 102 via passages 144, 146, respectively. In the embodiment shown, fluid is supplied to deformable chamber 102 from a fluid source 148 (illustrated schematically) or alternatively deformable chamber 102 is prefilled with fluid. Fluid is expressed from chamber 102 via pressure or compression, into fraction chambers 140, 142. In the illustrated embodiment, fraction chambers 140, 142 may be formed of a rigid material or structure to store fluid, or alternatively a deformable material or structure so that fluid is expressed therefrom for further processing steps.

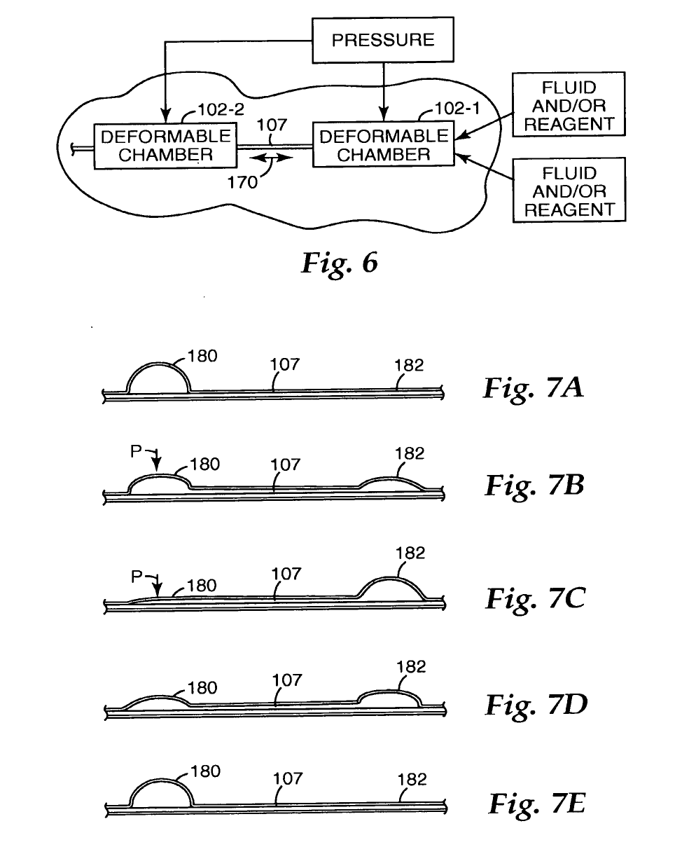

FIGS. 5-6 illustrate an apparatus including a plurality of deformable chambers 102-1 and 102-2 to implement a plurality of process or testing steps. As previously described each of the deformable chambers 102-1, 102-2 is formed of deformable or deformable material that compresses to express fluid therefrom upon application of pressure (either mechanically or electrically). In FIG. 5 the plurality of deformable chambers 102-1, 102-2 are arranged to supply fluid to a larger chamber 150. Chamber 150 can be a rigid or deformable chamber depending upon the process application. For example, the chamber 150 can be deformable to express fluid, or if fluid is to be stored in the chamber 150, the chamber 150 can be formed of a rigid structure or material.

In the embodiment shown in FIG. 5, deformable chamber 102-1 includes inlet 152 to receive a sample or fluid from fluid source 154 and outlet 156 to express fluid. Deformable chamber 102-2 is prefilled with a mixing solution or other fluid. Pressure is supplied via the pressure device 110 or by hand to squeeze or compress chambers 102-1 and 102-2 to express or eject fluid from chambers 102-1 and 102-2 into chamber 150 via flow passages 107-1 and 107-2.

FIG. 6 illustrates the plurality of deformable chambers 102-1, 102-2 arranged to implement a mixing sequence to stir or mix multiple fluids and/or reagent(s). As shown, fluids and/or reagents are supplied to the chamber 102-1. Chamber 102-1 is compressed or squeezed via pressure to express fluid from chamber 102-1 into chamber 102-2. Thereafter, as illustrated by arrow 170, fluid is expressed back and forth between chambers 102-1, 102-2 via the application of pressure. This back and forth movement or sequence agitates the fluid mixture to enhance mixing.

FIGS. 7A-7E illustrate an alternate embodiment of a mixing sequence including deformable chamber 180 and an expandable chamber 182 formed of an elastic material. As shown, initially, fluid is contained in chamber 180 as illustrated in FIG. 7A. Pressure P is supplied to chamber 180 to express fluid from chamber 180 into expandable chamber 182 as illustrated in FIGS. 7B-7C. After pressure to chamber 180 is released as illustrated in FIGS. 7D and 7E, chamber 182 collapses and fluid flows back into chamber 180. This sequence can be repeated for desired agitation. Once the mixing process is complete, fluid is retained or sealed in chamber 180 or expressed from chamber 180 for further processing.

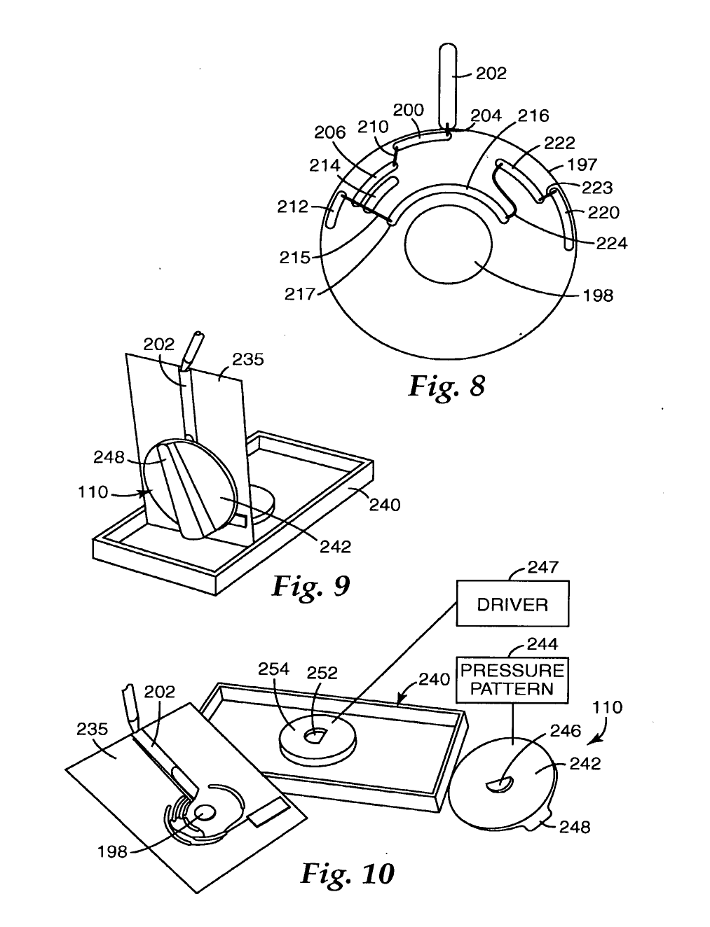

FIGS. 8-10 illustrate an apparatus having a plurality of deformable chambers arranged to collectively form a process pattern to implement a plurality of processing or testing steps. In the embodiment shown in FIG. 8, the process pattern is fabricated in a radial sequenced pattern. In the embodiment shown, the pattern includes a plurality of deformable chambers in combination with flow passages and other chambers that are positioned about the circumference of a multiple layer structure 197 having opening 198. As shown, the apparatus includes deformable chamber 200, which receives a fluidic sample, through inlet (not numbered). In the illustrated embodiment, the sample is supplied to the deformable chamber 200 through an introduction channel 202 by way of passage 204, for example using a syringe or other sample collection device.

Fluid is squeezed or expressed from chamber 200 through outlet (not numbered) into chamber 206 via passage 210. In an illustrative embodiment, chamber 206 can contain reagents or other materials that are mixed with the fluid or sample expressed from chamber 200. From chamber 206, fluid is squeezed into multiple fraction chambers 212, 214 via passage 215 to provide multiple samples for testing. Fluid in fraction chamber 212 is stored or tested via a testing device or sensor (not shown in FIG. 8). Fluid in fraction chamber 214 is expressed into larger chamber 216 for further processing (e.g., testing or analysis). In the illustrated embodiment, larger chamber 216 is sealed proximate inlet 217 while fluid is expressed from chamber 206 to chambers 212 and 214. Thereafter, inlet 217 is unsealed to express fluid from chamber 214 into chamber 216. Back flow from chamber 214 into chamber 212 and chamber 206 is restricted by a seal along the flow passage 215 or at chambers 212, 206, respectively so that fluid expressed from chamber 214 flows to chamber 216.

The illustrated pattern includes a prefilled deformable chamber 220. Illustratively chamber 220 is filled with a buffer solution. Fluid is squeezed from chamber 220 into chamber 222 through passage 223. In an illustrative embodiment, chamber 222 includes a reagent, for example a dehydrated reagent that is rehydrated via the fluid from chamber 220. The fluid may be mixed with the reagent by moving the fluid back and forth between chambers as previously illustrated in FIG. 6 or 7A-7E. Thereafter, the fluid is moved or expressed into chamber 216 through passage 224 and is combined with the sample fluid from fraction chamber 214 for testing (e.g., via a sensor or testing device not shown in FIG. 8).

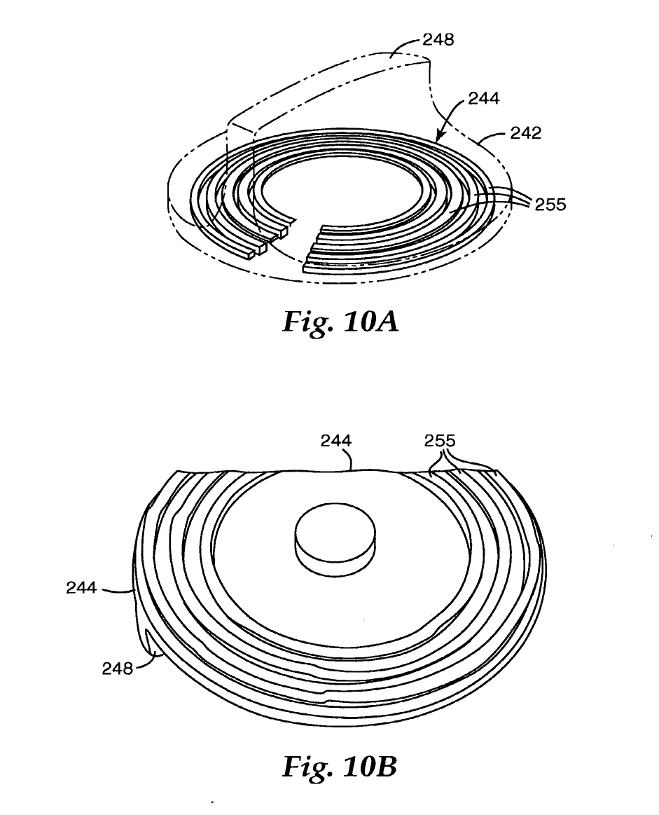

As shown in FIGS. 9-10 the processing or testing pattern is fabricated on a card-like base 235 for use in combination with a pressure device and tray 240. The pressure device 110 as shown is a rotatable dial 242 including a pressure pattern 244 (illustrated schematically in FIG. 10) on an underside surface of the dial 242. Dial 242 includes a raised hub portion 246 that is sized to extend through opening 198 on the card-like base 235. For operation, hub portion 246 extends through opening 198 and seats in recess 252 on a rotating body 254 of tray 240 as shown in FIG. 10.

As shown in FIG. 9, the card is supported in an upright vertical position to introduce a sample into channel 202. In an illustrative embodiment, for fluid introduction, dial 242 may be offset from the upright position and following fluid introduction, the dial 242 is turned to supplied pressure to close the sample introduction channel 202 at passage 204 which is illustratively formed of a deformable or deformable material. Alternately, the sample introduction channel 202 can be sealed using flap valves or alternate structures. Prior to introduction, in illustrative embodiments, the sample is pre-treated, for example using dilution, dialysis, precipitation, filtration, centrifugation, absorption, elution, or other processes.

Thereafter, the sample introduced is processed and/or tested via rotation of dial 242. As shown in FIG. 10, for processing, the apparatus is supported in tray 240 so that the hub portion 246 of dial 242 seats into the recess 252. Thereafter dial 242 is rotated to selectively supply pressure to the deformable chambers (e.g., 200, 206, 214, 220, 222 of FIG. 8) to implement sequential processing steps. In the illustrated embodiment, the dial 242 is rotated in a counterclockwise direction to execute the processing steps. Although a counterclockwise rotation direction is disclosed, the dial 242 and pattern can be implemented in a clockwise direction as well.

In the illustrated embodiment, dial 242 is rotated via driver (e.g. motor) 247 (illustrated schematically) which rotates the rotating body 254 of tray 240. Rotation of the rotating body 254 via driver 247 is imparted to the dial 242 via contact between the flat surface of hub portion 246 with the flat surface formed in recess 252 of the rotating body 254. The driver or motor 247 is configured or designed to rotate the rotating body 254 and thus dial 242 (and pressure pattern 244) at a set speed or velocity to provide desired timing for execution of the processing sequence or steps. Although a particular interface between the driver 247 and dial 242 or pressure pattern 244 is shown, application is not limited to the particular interface shown. Alternatively, the dial 242 can be rotated by hand, for example using handle 248.

FIGS. 10A and 10B illustrate embodiments of a pressure pattern 244 on dial 242 having a particular contour as shown in FIG. 10B designed to implement the multiple processing steps in a radially sequenced pattern as illustrated in FIGS. 8-10. As shown in FIGS. 10A-10B, the pressure pattern 244 includes a plurality of circumferentially spaced ribs 255 to squeeze various chambers to express fluid and/or seal various passages or chambers to restrict fluid flow therethrough as dial 242 is rotated.

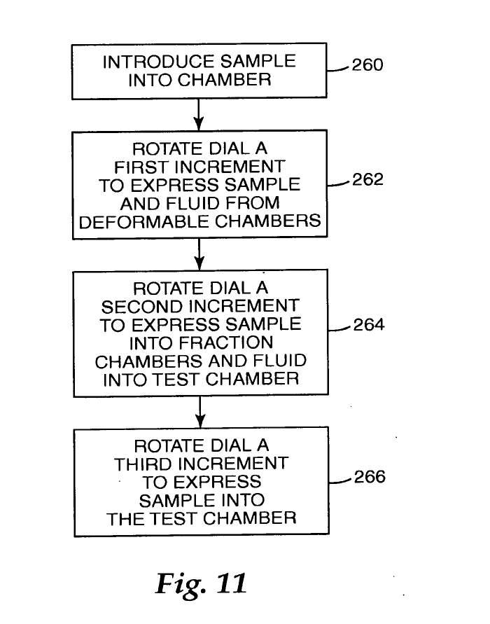

The sequence of processing steps executed via dial 242 for the pattern illustrated in FIGS. 8-10 is shown in FIG. 11. As shown in FIG. 11, in step 260, a fluid sample is introduced into chamber 200. As illustrated in step 262, dial 242 is rotated a first increment to express fluid from sample chamber 200 and pre-filled chamber 220. Fluid is expressed from chamber 200 into chamber 206. Back flow from chamber 200 to channel 202 is controlled via a flow restrictor or seal on the pressure pattern 244. During step 262, fluid is also expressed from the pre-filled chamber into chamber 222. In step 264, the dial 242 is rotated a second increment to express fluid from chamber 206 into fraction chambers 212, 214 and to express fluid from chamber 222 to the test chamber 216. Again back flow is restricted via a flow restrictor or seal on the pressure pattern 244. In step 266, the dial 242 is rotated a third increment to express the sample fluid from fraction chamber 214 into the test chamber 216. In an illustrated embodiment, dial is rotated in 30 degree increments, although application is not limited to rotation in 30 degree increments. As shown, the pattern is radially arranged to sequentially apply pressure to multiple chambers to implement multiple process steps in a single rotation increment.

As discussed, the flow of fluid is controlled via flow restrictors or seals. Flow restrictors can be fabricated directly on the multiple layered structure as previously described with respect to FIG. 3 or can be incorporated into the pressure pattern 244 formed on the dial 242. For example, a normally closed passage can be fabricated on the multiple layered structure using the flow restrictor illustrated in FIG. 3. The normally closed passage opens in response to application of pressure to release fluid from a chamber. Alternatively, the flow restrictor provides a normally open passage, which is sealed via pressure after a chamber is filled to retain fluid. Other flow restrictor structures can be fabricated on the multiple layered structure including a flap valve or similar structure. For example, in an illustrated embodiment, the flow restrictor is formed of a stiff material sandwiched between multiple layers or formed on one or more of the layers (illustrated in FIG. 2) to form a blister that once collapsed can not be reset.

Alternatively, flow restrictors can be incorporated into the pressure pattern 244 on dial 242 or other pressure device to intermittently or temporarily seal or restrict fluid flow by supplying pressure to temporarily squeeze or impinge the flow passage 107. The restrictor is formed of a raised portion (not shown) that applies a localized force to deform or squeeze passages to seal or restrict flow therethrough. In an illustrated embodiment, once the raised portion is removed the squeezed channel or passage assumes its predeformed shape to allow fluid to flow therethrough. If the channel or passage is to stay shut for multiple processing steps, the raised portion or rib 255 is contoured to provide continued pressure as the dial 242 is rotated or advanced for subsequent processing or testing steps.

In another embodiment, the pressure pattern 244 is used to permanently seal the chamber. For example, as previously described with respect to FIG. 3, the pressure pattern can be used to bind or seal the sealing portion 130 of a normally opened passage. Thus, the passage allows for fluid flow prior to contact with the raised portions or ribs of the pressure pattern 244. Following contact with the pressure pattern, the passage is sealed.

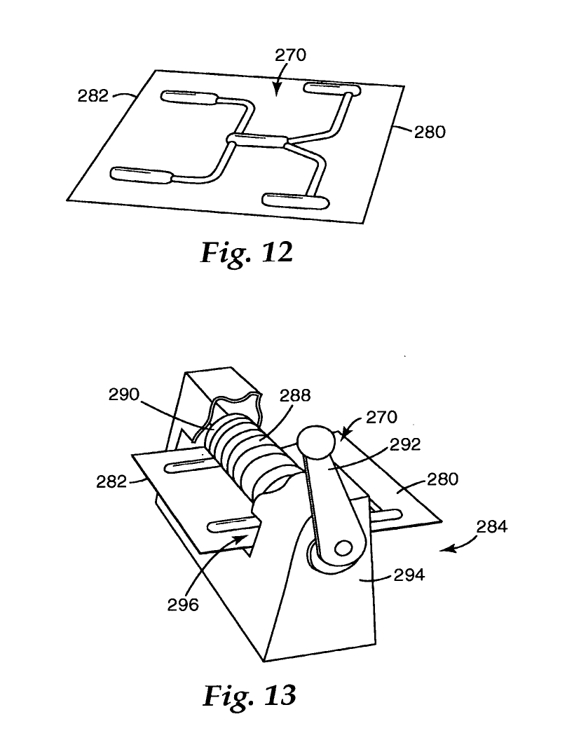

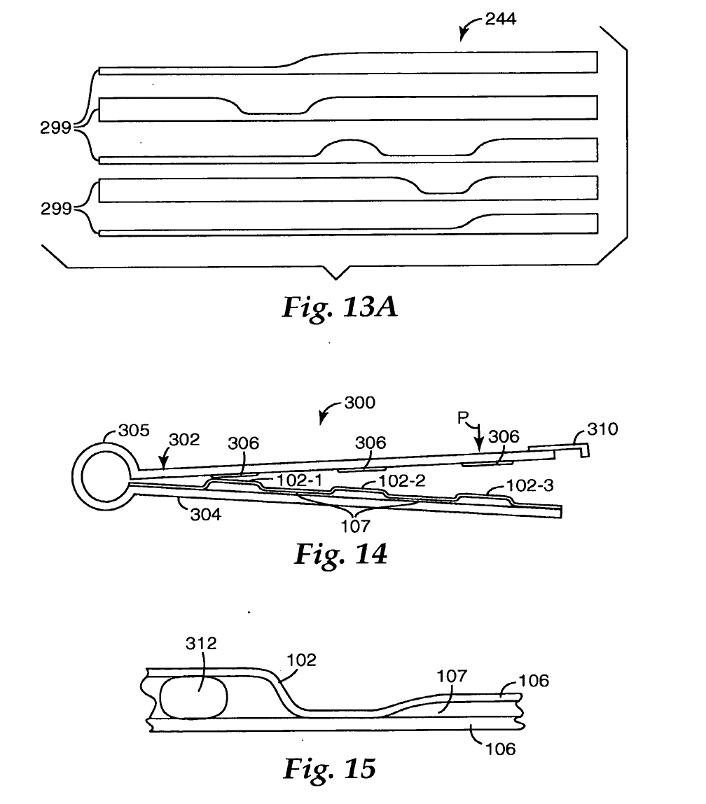

In another illustrated embodiment shown in FIGS. 12-13, a plurality of chambers and passages are fabricated on a multiple layered structure to form a linear sequenced pattern to implement multiple process or testing steps. In the illustrated device shown in FIG. 12, the chambers and passages are linearly sequenced from end 280 to end 282 of a multiple layered card-like structure 270 which illustratively is relatively rigid or alternatively relatively flexible As shown in FIG. 13, the process steps are executed via a linear sequenced pressure device 284. In the illustrated embodiment, the linear sequenced pressure device 284 includes a rotatable cylindrical drum 288 having a pressure pattern 290 about an outer circumference of the drum. Drum 288 is rotated via handle 292 coupled to base 294. The card-like structure 270 is inserted into a nip or passageway 296 between the rotatable drum 288 and base 294 to execute the test or processing sequence. Rotation of the handle 292 rotates drum 288 and linearly advances or moves the card-like structure 270 through passageway 296.

Fluid or sample is moved through the test or processing sequence via interface of the card-like structure 270 with the pressure pattern 290 as previously described. In an alternate embodiment, the pressure pattern is formed on a pressure plate or structure (not shown) instead of drum 288. The pressure plate or structure (not shown) having the pressure pattern thereon is inserted into the nip or passageway 296 with the card-like structure 270 to linearly actuate the test or processing sequence as the card-like structure 270 and the pressure plate or structure are advanced through the passageway 296. Pressure is sequentially supplied to the chambers and/or passages through application of pressure through the pressure pattern on the pressure plate or structure as the card-like structure 270 and pressure plate or structure are advanced via rotation of drum 288. Since the pressure pattern is formed separately from the drum Ng, the pressure device 284 is universal and can be used for different processing patterns or structures. As described, the pressure plate or structure having the pressure pattern thereon can be separate from or coupled (e.g. removably coupled or fixedly coupled) to the card-like structure 270.

FIG. 13A illustrates a pressure pattern 244 for a linearly sequenced pressure plate or structure including a plurality of pressure ribs or ridges 299, which are contoured to supply pressure to deform and/or seal the chambers and passages to selectively implement the particular process steps or sequence as previously described.

FIG. 14 illustrates an apparatus 300 having a pressure device 302 hingedly coupled to a multi-layer portion 304 at hinge 305. As shown, the pressure device 302 includes a plurality (or at least one) pressure ridges 306 spaced from the hinge 305. The ridges 306 are spaced relative to deformable chambers 102-1, 102-2 and 102-3 or alternately passages 107 fabricated on the multi-layered portion 304, so that as pressure P is applied, the pressure device 302 pivots about hinge 305, and the pressure ridges 306 sequentially contact and compress chambers 102-1, 102-2, 102-3 to move fluid along a process flow path.

As pressure P is applied, the pressure device 302 pivots until pressure device 302 abuts the multiple-layered portion 304 and the pressure device 302 is secured via a latching device or hook 310 (illustrated schematically). As shown, in FIG. 15, the rate at which fluid is expressed or flows can be controlled using a timing mass or portion 312 comprising a viscous mass disposed within the deformable chamber 102. The viscosity of the viscous mass is designed based upon the applied pressure and desired timing or flow rate.

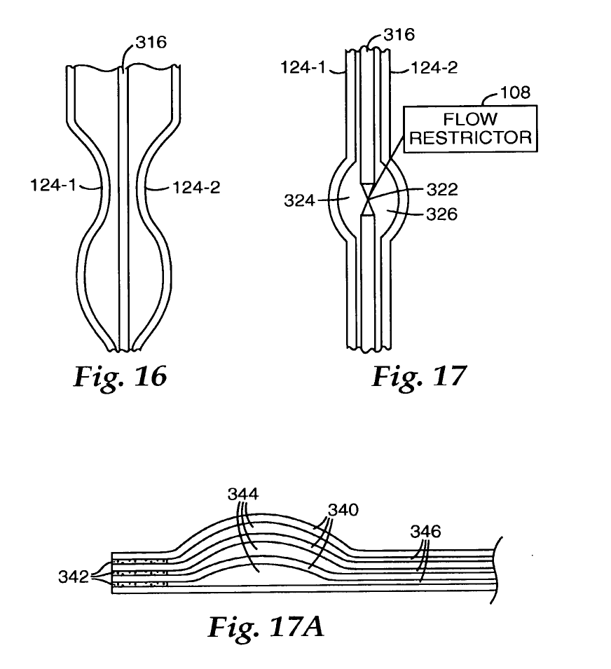

In previous embodiments shown, the flow pattern or chambers are formed on a single face of a multi-layered structure or card. As shown in FIGS. 16-17, the flow pattern includes chambers formed on opposed faces or sides of the multi-layered structure or card to form a dual sided card or apparatus. In particular, in the embodiment shown in FIG. 16, a first layer or layers 124-1 are formed on a first side of layer or base 316 and a second layer or layers 124-2 are fabricated on a second side of layer or base 316 to form the dual sided card or apparatus having one or more chamber on opposed sides of the card or apparatus. In the embodiment illustrated in FIG. 17, the layer or card 316 includes a flow opening or passage 322 therethrough to provide a flow path that extends along both sides of the card or apparatus and through the layer or base 316.

In the illustrated embodiment in FIG. 17, the flow opening 322 provides a passage between a first chamber 324 on the first side of the card or apparatus and a second chamber 326 on the second side of the card or apparatus. In the illustrated embodiment, flow through the flow passage 322 is controlled via a flow restrictor 108, as shown. Flow restrictor 108 can be fabricated of various constructions such as frangible seal that is opened upon application of sufficient pressure. Thus, the dual sided structure allows fluids to flow in parallel on opposed sides of the card or apparatus until the fluids are combined in a common chamber.

In another embodiment illustrated in FIG. 17A, a plurality of layers 340 are joined or adhered at 342 to form a plurality of parallel chambers 344 and passages 346 to provide a series of parallel flow paths that are actuated simultaneously by hand or using a pressure device as previously described. Although FIG. 17A illustrates three parallel chambers, application is not limited to a particular number of parallel chambers as will be appreciated by those skilled in the art.

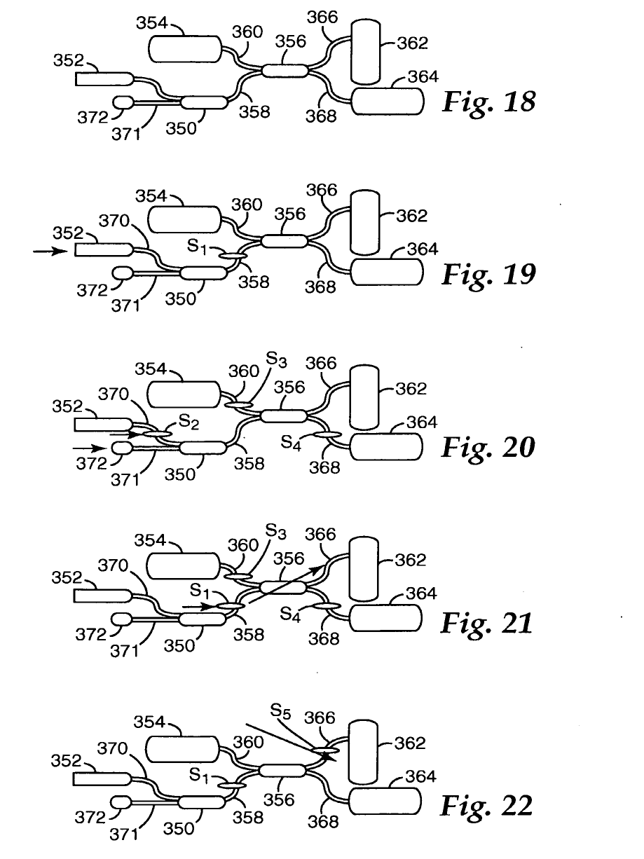

FIGS. 18-22 sequentially illustrate a processing sequence implementable using a pattern of deformable chambers and passages. As shown in FIG. 18, the pattern includes a deformable mixing chamber 350 that receives a fluid sample from an introduction channel 352 and a deformable chamber 354 which illustratively is filled with an eluent fluid. Deformable chambers 350 and 354 are connected to a capture chamber 356 via passages 358, 360, respectively. Capture chamber 356 is connected to a waste chamber 362 and an eluent chamber 364 via passages 366, 368, respectively. In the illustrated embodiment, the capture chamber 356 includes a capture medium (not shown) to isolate analyte from the sample. Waste from the introductory fluid is stored in chamber 362 and eluent dispensed from the capture chamber 356 is collected in chamber 364 for testing.

As shown in FIG. 19, the passage 358 between mixing chamber 350 and capture chamber 356 is closed, by seal S₁ while sample is introduced into channel 352 to chamber 350. The introduced sample is collected in the mixing chamber 350. In another step, as illustrated in FIG. 20, seal S₁ in passage 358 is opened and passage 370 from introduction channel 352 is closed by seal S₂, and an additive fluid is expressed from chamber 372 through passage 371 and mixed with the sample in chamber 350. Thereafter passage 370 remains closed and passages 360 and 368 are closed by seals S₃ and S₄, respectively. Fluid is expressed from chamber 350 through open passage 358 into capture chamber 356 to isolate an analyte. In a further processing step, fluid is dispensed from the capture chamber 356 through passage 366 and collected in the waste chamber 362, while passages 358, 360 and 368 are closed by seals S₁, S₃ and S₄, respectively, as shown in FIG. 21.

In an illustrated embodiment, waste chamber 362 is a rigid chamber. Fluid flow from the waste chamber 362 is restricted via a one way flow restrictor so that fluid is sealed within chamber 362. An example embodiment of a one way valve includes a flap formed of an inert material such as polypropylene that moves in a single direction to allow fluid flow in one direction and restrict fluid flow in the opposite direction.

The analyte is isolated from the sample in the capture chamber 356 via the capture medium (not shown). It may be necessary to isolate and, in some sense, concentrate the analyte. Examples of suitable capture media include, but are not limited to, beads, a porous membrane, a foam, a frit, a screen, or combinations thereof. The capture media may be coated with a ligand specific to the analyte, e.g., an antibody. In other embodiments, other means for isolating the analyte may be used. In a next processing step illustrated in FIG. 22, flow passages 358 and 366 are closed via seals S₁ and S₅, respectively, fluid is expressed from chamber 354. The expressed fluid flows through passage 360 (now open) into the capture chamber 356 and then through passage 368 (now open) into the eluate chamber 364. At least some of the analyte captured by the capture medium is then released therefrom.

The isolated fluid in the chamber 364 is tested using a testing device or sensor (not shown). In an illustrative embodiment, the testing device is a colorimetric sensor, which may include, for example, a polydiacetylene material, as described in U.S. Publication No. U.S. 2004/0132217 A1, filed on Dec. 16, 2003, and U.S. Patent Publication No. 2006/0134796 A1, filed on Dec. 17, 2004, both entitled, “COLORIMETRIC SENSORS CONSTRUCTED OF DIACETYLENE MATERIALS”. Other testing devices and/or reagents suitable for use with the device described herein are those described in U.S. application Ser. No. 11/015,166, now U.S. Publication No. U.S. 2005/0153370A1 entitled “Method of Enhancing Signal Detection of Cell-Wall Components of Cells,” filed on Dec. 17, 2004.

In an indirect assay, the testing device detects the presence of a reagent adapted to react with the analyte rather than detecting the analyte itself. In an illustrative embodiment, the reagent and analyte react, and then any remaining reagent (i.e., the reagent that has not reacted with the analyte to form a conjugate of the reactant/analyte) reacts with the testing device. In contrast, if a direct assay is used, a reagent that reacts with the analyte may not be necessary, or the analyte is detected directly. Thereafter, the testing device provides a visual indicium of the presence and/or quantity of reagent and/or analyte. It is preferred that the analyte and/or reagent are given sufficient time to react prior to contacting the testing device. The passages can be sized to control fluid flow to provide sufficient time or interval for the reaction.

In one illustrative embodiment of an indirect assay, the reagent reacts with a surface of the testing device (e.g., initially a red color), and the testing device changes color as the reagent reacts with the testing device, for example, from red to blue. The testing device may also be configured to provide an indicium of the quantity of reagent present (which in an indirect assay inversely represents the quantity of analyte present in the sample of material). For example, the testing device may change color, where the intensity or hue of the color changes depending upon the amount of reagent present.

As disclosed, chambers and passages of the device described herein can be packed with reagents or dried substances that are rehydrated via fluid flow. The chambers or passages described can be formed of both elastomeric materials or rigid materials depending upon the particular process application. For example, both rigid and deformable chambers or passages can be formed on the multi-layer structure using different layers and patterns. Deformable passages or chambers are advantageous in that the deformable passages or chambers minimize the introduction of entrained air.

Typically, a deformable receiving passage and chamber will be flush with the structure, free of air, and expand to accommodate fluid during use, and flatten again after use to keep air from being introduced or entrained during or after processing. In illustrated embodiments, the passage serve as “valves” to restrict or permit fluid flow between chambers. In illustrated embodiments, the passages serve as processors by modifying a fluid stream as it flows between chambers. Examples of fluid modification include mixing operations with static mixers or dissolution of a surface coating contained within the passage. The processing pattern, for example can macerate a solid substance into constituents via expressing a fluidic sample from one chamber through a passage with a series of cutters into another chamber.

As described, in illustrative embodiments, the processing pattern is formed on a relative low profile structure, which in an illustrative embodiment is about the size of a postcard and can be rigid or flexible. The multiple layered structure as described provides a disposable device which includes prefilled fluids and reagents to provide a self contained and sterile apparatus. Alternatively, the processing pattern can be formed on a larger structure having larger chambers and passages which is more suited to industries requiring larger samples, such as the food industry.

Depending upon the particular flow pattern, multiple process steps can be sequentially implemented via a corresponding pressure pattern on a pressure device. As described, by selectively pressing on the chambers and passages, fluids, liquids, gels or other flowable compositions can be introduced and expressed, stored, and released from and between the chambers, to and from other chambers and to and from devices. As referenced herein, the deformable chambers are formed of a multiple layer structure to express or eject fluids upon the application of pressure and the construction and function of the deformable chambers is not limited to the specific embodiments disclosed herein. As referenced herein, “fluid” refers to any flowable liquid, gel, powder or other flowable composition.

The complete disclosures of the patents, patent documents and publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. (canceled)

2. An apparatus for processing a fluidic sample of material comprising:
a processing device having a processing pattern comprising at least one deformable chamber in fluid communication with at least one flow passage; and
a pressure device having a pressure pattern formed thereon to supply pressure to the at least one deformable chamber.

3. The apparatus of claim 2, wherein the at least one deformable chamber comprises an expandable elastic material.

4. The apparatus of claim 2, wherein the processing device comprises a plurality of deformable chambers.

5. The apparatus of claim 2 wherein the at least one flow passage includes a flow restrictor that opens or closes upon the application of pressure to control fluid flow.

6. The apparatus of claim 2 wherein the at least one deformable chamber is prefilled with a fluid.

7. The apparatus of claim 2 wherein the at least one deformable chamber includes an inlet to receive a fluid sample and an outlet in fluid communication with the flow passage.

8. The apparatus of claim 2 including a first deformable chamber and a second deformable chamber and the first and second deformable chambers are in fluid communication with a third chamber having a larger capacity than the first and second deformable chambers.

9. The apparatus of claim 2, further comprising a mixing chamber in fluid communication with at least one deformable chamber.

10. The apparatus of claim 2 wherein the flow passage or passages are formed of an elastic or deformable material.

11. The apparatus of claim 2 further comprising at least one chamber formed of a rigid material.

12. The apparatus of claim 2, further comprising a plurality of fraction chambers in fluid communication with at least one deformable chamber.

13. The apparatus of claim 2 wherein the apparatus includes at least one capture chamber having a capture medium or reagent disposed therein.

14. (canceled)

15. The apparatus of claim 2 wherein the apparatus includes a plurality of chambers arranged in one of a radial or linear sequenced processing pattern and the pressure device includes one of a radial or linear sequenced pressure pattern.

16. The apparatus of claim 15 wherein the plurality of chambers are arranged in the radial sequenced pattern and the pressure device comprises a dial coupled to a rotating body of the processing device and rotatable in a clockwise or a counterclockwise direction.

17. The apparatus of claim 15 wherein the plurality of chambers are arranged in the linear sequenced pattern and the pressure device comprises a drum rotationally coupled to a base and rotation of the drum sequentially supplies pressure through a pressure pattern coupled to the drum or separate from the drum.

18. The apparatus of claim 2 wherein the pressure pattern includes raised portions or ribs contoured to compress the at least one flow passage of the processing device to temporarily restrict fluid flow or seal the at least one flow passage.

19. The apparatus of claim 2 wherein the processing device is flexible or relatively rigid.

20. A method of mixing a sample, comprising the steps of:
introducing a sample of material into a first deformable chamber through an introductory channel; and
applying pressure to the first deformable chamber to express the sample of material from the deformable chamber into a deformable flow passage connected to the first deformable chamber and/or to a second deformable chamber connected to the deformable flow passage; and
applying pressure to the deformable flow passage and/or second deformable chamber to express the sample of material from the deformable flow passage and/or second deformable chamber to the first deformable chamber.

21. The method of claim 20, further comprising the step of:
applying pressure to a third deformable chamber pre-filled with fluid to express the pre-filled fluid from the third chamber to either the first deformable chamber, the deformable flow passage and/or the second deformable chamber.

22. A method of processing a sample, comprising the steps of:
providing the apparatus of claim 2;
introducing a sample into the at least one deformable chamber;
placing the pressure device in contact with the processing device; and
moving the pressure device relative to the processing device to apply pressure to the at least one deformable chamber.
